(19) United States
(12) Patent Application Publication
(10) Pub. No.: US 2003/0072997 A1
(43) Pub. Date: Apr. 17, 2003

(54) Apparatus and method for connecting cells of a battery

(76) Inventors: Denis Estreich, Sarreguemines (FR); Randall F. Brantley, Fishers, IN (US)

Correspondence Address: MARGARET A. DOBROWITSKY, DELPHI TECHNOLOGIES, INC., Legal Staff, Mail Code: 480-414-420, P.O. Box 5052, Troy, MI, 48007-5052, US

(21) Appl. No.: 09/977,108

(22) Filed: Oct. 12, 2001

(51) Int. Cl. H01M 2/02; H01M 2/24; H01M 2/04

(52) U.S. Cl. 429/153; 429/160; 429/177

(57) ABSTRACT

A battery having a battery housing defining a receiving area, the housing is configured to receive and engage a plurality of cells each having a cell housing and a cell element received and engaged within each of the cell housings. The cell element has a plurality of positive plates each having a positive tab portion depending outwardly from a periphery, a plurality of negative plates each having a negative tab portion depending outwardly from a periphery, and a nonconductive separator disposed in between the plurality of positive plates and the plurality of negative plates. A positive plate having a positive post is secured to each of the positive tab portions and a negative plate having a negative post is secured to each of the negative tab portions. An inner cover is inserted into the housing after the cells are inserted therein and the inner cover is configured to cover the positive and negative plates while allowing a portion of the positive and negative posts to pass therethough. The posts are then electrically secured to each other.

### TECHNICAL FIELD

This application relates generally to the field of batteries. More specifically, this application relates to a battery having a plurality of battery cells and a method manufacturing the same.

### BACKGROUND

Lead-acid batteries have a plurality of cells each having a cell element, which is exposed to electrolytes in order to generate electrical current through a chemical reaction. The cell elements include a plurality of positive and negative plates with a plurality of separators disposed therebetween. Each of the plates (positive and negative) includes a tab portion. In some configurations, the cell elements are maintained under compression to provide constant contact between the plates and the separators.

The cells are connected to each other and the outer most cells are also connected to a means for providing a positive terminal and a negative terminal.

### SUMMARY

A battery comprising: a battery housing defining a receiving area, the housing is configured to receive and engage a plurality of cells each having a cell housing and a cell element received and engaged within each of the cell housings. The cell element has a plurality of positive plates each having a positive tab portion depending outwardly from a periphery, a plurality of negative plates each having a negative tab portion depending outwardly from a periphery, and a nonconductive separator disposed in between the plurality of positive plates and the plurality of negative plates. A positive plate having a positive post is secured to each of the positive tab portions and a negative plate having a negative post is secured to each of the negative tab portions. An inner cover is inserted into the housing after the cells are inserted therein and the inner cover is configured to cover the positive and negative plates while allowing a portion of the positive and negative posts to pass therethough. The posts are then electrically secured to each other.

A method for assembling a battery having a plurality of cells, comprising: inserting a plurality of cells each having a cell housing into a battery housing having an internal configuration for receiving and engaging a complementary external configuration of the cell housing; covering the cells with a cover and electrically connecting each of the plurality of cells in series by providing a plurality of lead inserts for making contact with a positive post and a negative post of the plurality of cells, the post protruding through the cover.

The above-described and other features and advantages of the present invention will be appreciated and understood by those skilled in the art from the following detailed description, drawings, and appended claims.

### BRIEF DESCRIPTION OF THE DRAWINGS

FIG. 1 is a perspective view of an exemplary embodiment of a battery case;

FIG. 2 is a top plan view of the figure one embodiment;

FIG. 3 is a view along lines 3-3 of the FIG. 2;

FIG. 4 is a view along lines 4-4 of the FIG. 2;

FIG. 5 is a view along lines 5-5 of the FIG. 2;

FIG. 6 is a side elevation view of a cell;

FIG. 7 is a perspective view of a battery constructed in accordance with an exemplary embodiment of the present invention;

FIG. 8 is a view along lines 8-8 of the FIG. 6;

FIG. 9 is an exploded view of a portion of a battery cell;

FIG. 10 is a perspective view of a battery cell constructed in accordance with an exemplary embodiment of the present invention;

FIGS. 11-12 are perspective views of a battery cell constructed in accordance with an exemplary embodiment of the present invention;

FIG. 13 is a cross sectional view of a portion of the attachment process for the cells of a battery constructed in accordance with an exemplary embodiment of the present invention; and

FIG. 14 is a perspective view of an assembled battery cell.

### DESCRIPTION OF THE PREFERRED EMBODIMENT

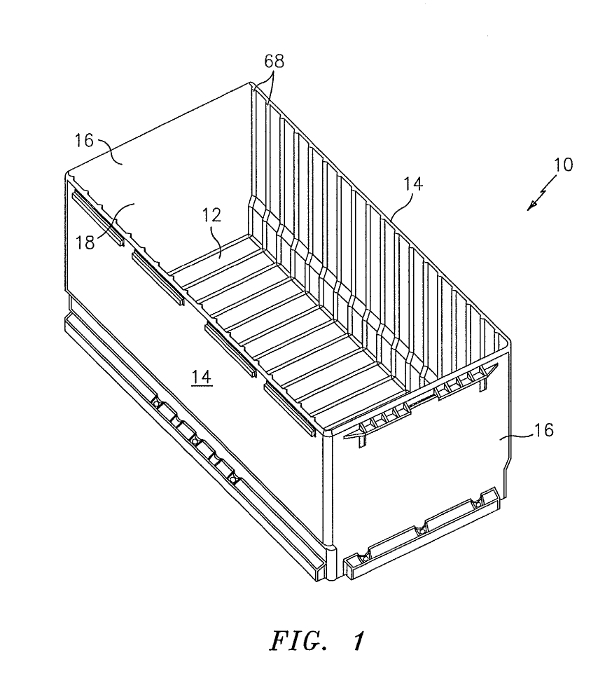

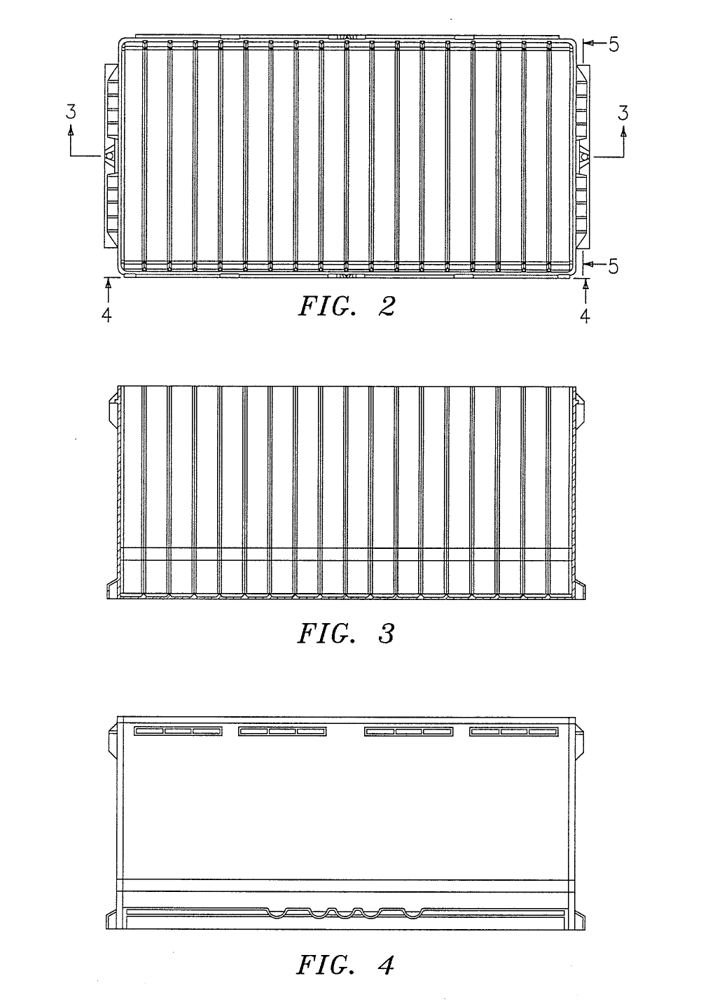

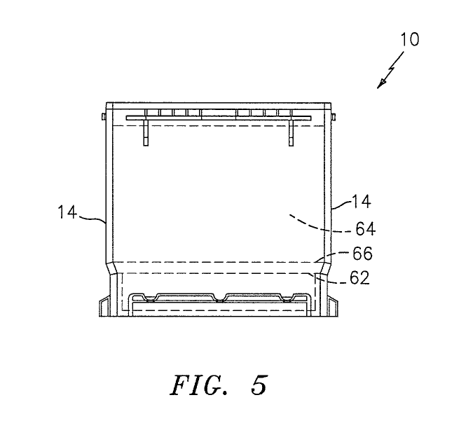

Referring to the Figures and in particular to FIGS. 1-5, a battery case 10 for a battery constructed in accordance with an exemplary embodiment of the present invention is illustrated. Battery case 10 includes a bottom 12, a pair of opposing sidewalls 14 and a pair of end walls 16. Bottom 12, sidewalls 14 and end walls 16 define an interior compartment 18.

One contemplating use for the battery is vehicular applications however; the battery is contemplated for use in any application requiring an electric storage medium.

The inner surface of sidewalls 14 and the inner surface of bottom 12 are configured to receive and engage a plurality of cells 20 which are inserted into interior compartment 18.

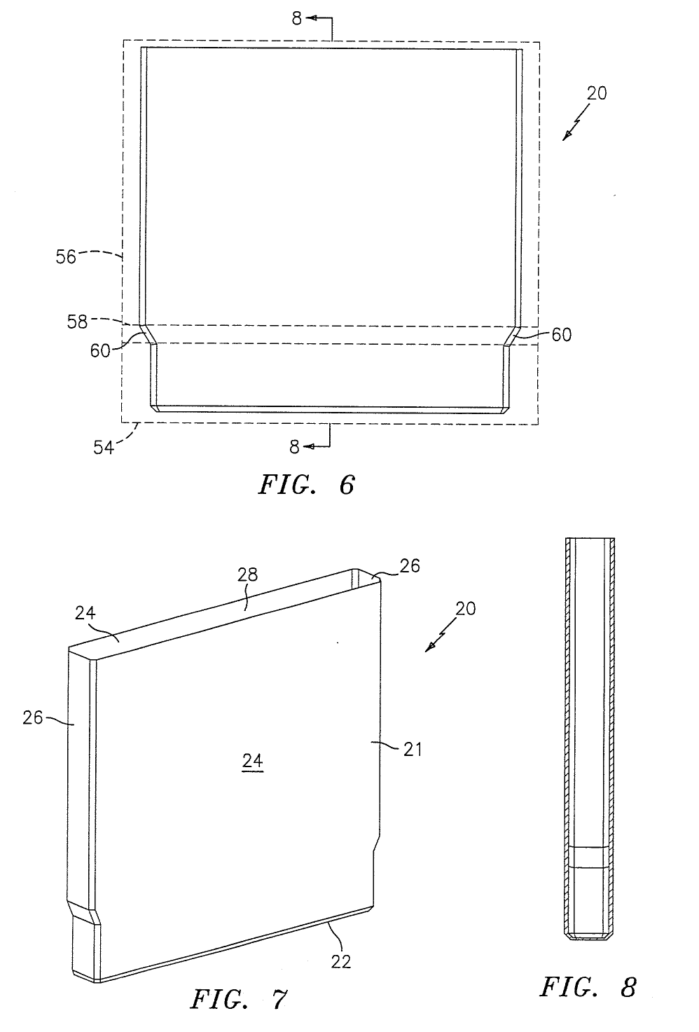

Referring now to FIGS. 6-10 an exemplary embodiment of cell 20 is illustrated. Each cell 20 has a housing 21 with a bottom 22, a pair of opposing sidewalls 24 and a pair of end walls 26 for defining an internal compartment 28. In an exemplary embodiment, bottom 22, sidewalls 24 and end walls 26 are made of a polymer, such as, but not limited, to ABS plastic that is resistance to the corrosive qualities of the electrolyte.

Preferred dimensions of housing 21 are illustrated in the Figures however, the scope of the present invention is not intended to be limited by the dimensions and configuration illustrated in the Figures.

Internal compartment 28 is configured to receive a cell element comprising: a plurality of positive battery plates 30, a plurality of separators 32, and a plurality of negative battery plates 34. Positive battery plates 30, separators 32 and negative battery plates 34 are preferably configured into a stack 36 of alternating positive and negative plates separated by separators 32.

In addition, an electrolyte is inserted into compartment 28 for generating an electrical charge.

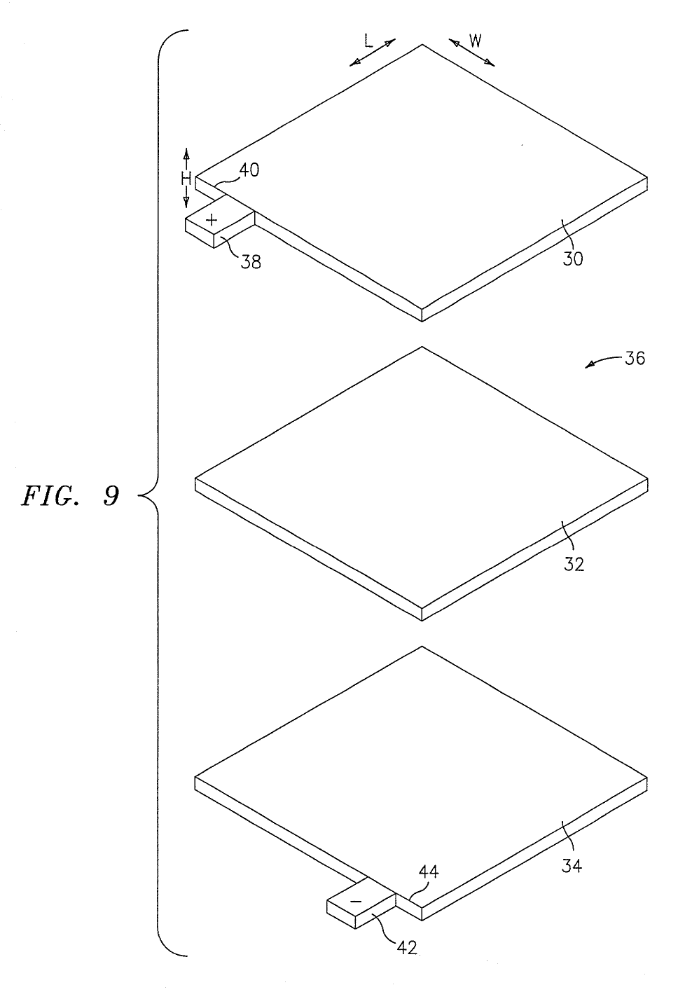

Stack 36 is a compressible stack that alternates between positive plates 30 and negative plates 34 with a separator 32 between the opposing polarity plates. FIG. 9 illustrates stack 36 with one positive plate 30, one separator 32 and one negative plate 34, however any number of plates and separators comprising cell 20 is considered within the scope of the present invention.

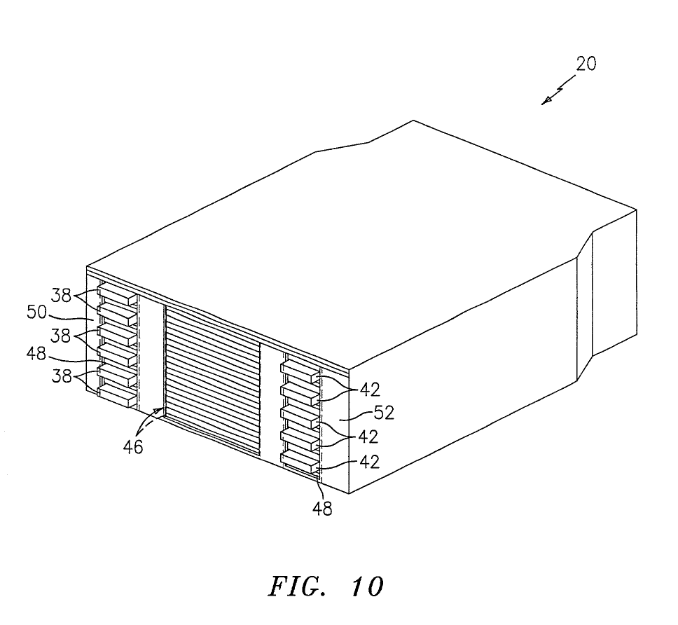

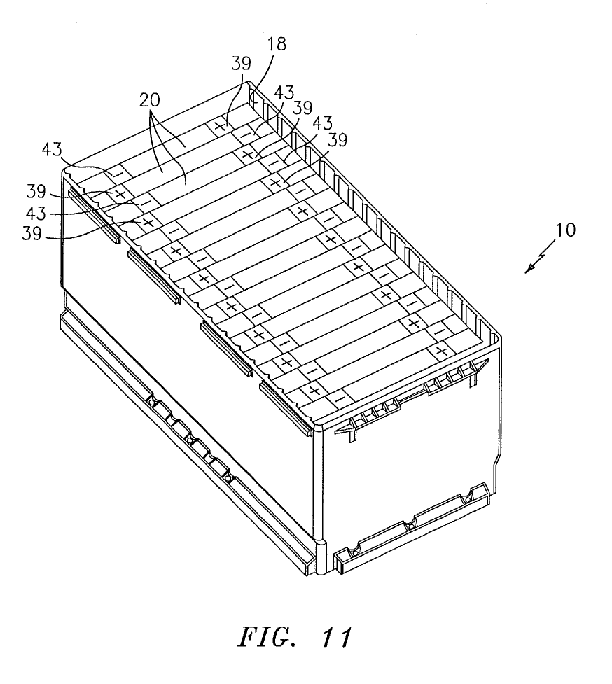

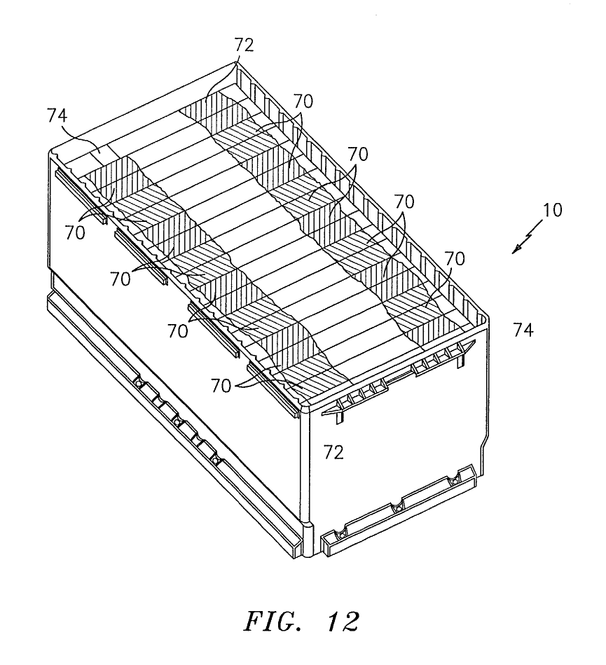

As illustrated in FIGS. 9 and 10, positive battery plates 30 have a positive lug 38 extending therefrom. Positive lug 38 extends outwardly from one edge and is offset from an adjacent edge of positive battery plate 30 by a predetermined offset distance 40.

Negative battery plates 34 each have a negative lug 42 which extends from one edge and is offset from an adjacent edge by a predetermined offset distance 44. In accordance with an exemplary embodiment the edges from which lugs 38 and 42 extend are aligned with each other and the edges from which offset distances are defined are arranged to be opposite each other.

Thus, and in an assembled state positive lugs 38 will align with each other and negative lugs 42 will also align with each other.

Offset distance 44 is different from offset distance 40. Accordingly, the positive lugs will align with each other on an edge of an assembled stack at a first position from an adjacent edge. The negative lugs will align with each other on the same edge as the positive stack however, the negative lugs will be located at a second position away from the opposite adjacent edge.

Thus, the stack of positive lugs will be located a first distance away from a first adjacent edge and the stack of negative lugs will be located a second distance away from a second adjacent edge, the first edge being opposite to the second edge.

Accordingly, the position of positive and negative lugs is determined by their distance from the edges of the stack 36. Alternatively, the positive and negative lugs are located at the same distance from the edges of stack 36 and their properties are determined by the configuration of positive and negative lugs. For example, and for purposes of explanation, positive lugs are smaller than negative lugs. In yet another alternative, each positive lug is demarcated with a plus (+) sign and each negative lug is demarcated with a negative (−) sign. Thus, the polarity of the lugs is easily determined upon visual inspection.

Referring now to FIG. 10 and in accordance with an exemplary embodiment, a plurality of positive plates 30, separators 32 and negative plates 34 are inserted into internal compartment 28 under compression, In this configuration, a plurality of negative and positive lugs depending out of an open end portion of compartment 28.

As an alternative and as illustrated by the dashed lines in FIG. 10, an end portion 46 is secured in the opening into internal compartment 28.

End portion 46 defines a pair of lug openings 48 for receiving the stacked lugs 38 and 42. End portion 46 includes a first spacer 50 positioned at one end of end portion 46 and a second spacer 52 located at an opposite end of end portion 46. First spacer 50 has a width corresponding to predetermine distance 40 and second spacer 52 has a width corresponding to predetermine distance 44.

Accordingly, end portion 46 is configured to secure stack 36 into cell 20 so that a plurality of positive lugs is located at one end and a plurality of negative lugs is located at the other.

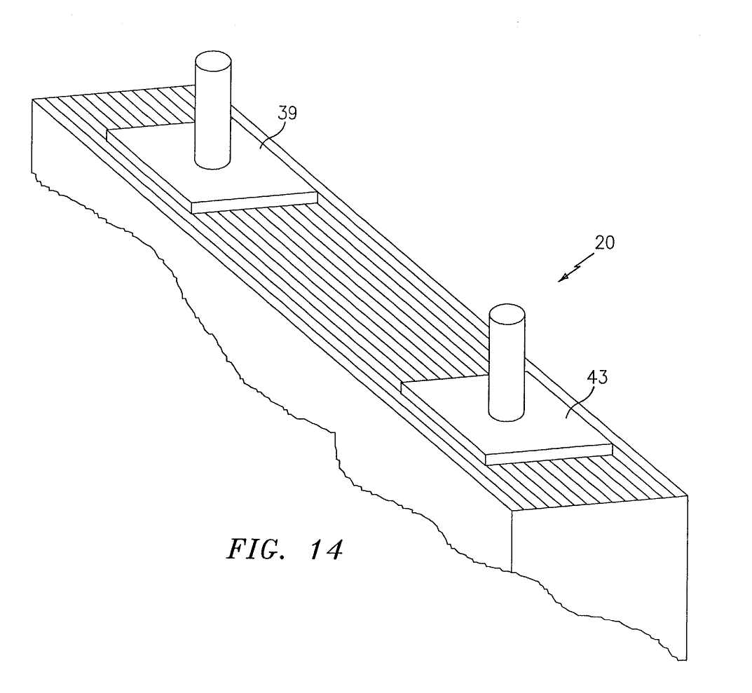

The positive lugs are secured to a positive plate strap 39 and the negative lugs are secured to a negative plate strap 43 (FIGS. 13 and 14). In an exemplary embodiment, plate straps 39 and 43 are lead castings with a post. The straps are “cast on straps” and are cast to the positive or negative tabs.

The sidewalls of each cell are configured to have a lower end portion 54. Lower end portion 54 has a slightly smaller width than an upper portion 56. In addition, a transitional portion 58 is disposed between lower end portion 54 and upper portion 56. In order to facilitate the configuration of cell 20, sidewalls 26 are configured to have an angled portion 60 which corresponds to transitional portion 58.

In accordance with an exemplary embodiment of the present invention, angled portion 60 is configured to have a 25 degree angle with respect to lower end portion 54. It is contemplated that angled portion 60 may have a configuration greater or less than 25 degrees. In addition, and as an alternative embodiment, angled portion 60 is configured to have a circular or other non-linear arrangement in order to facilitate the increase of width from lower end portion 54 to upper portion 56.

Referring now to FIGS. 1 and 5, sidewalls 14 of battery case 10 are configured to accommodate lower end portion 54 upper portion 56 and transitional portion 58 of cell 20. This is facilitated by sidewalls 14 defining a complementary lower end portion 62, upper portion 64 and transitional portion 66 for receiving an engaging cell 20. In addition, each of the aforementioned portions which are defined by defined by sidewalls 14, are also further defined by a pair of guide walls 68 configured to protrude outwardly from the inner surface of sidewalls 14 and bottom 12.

Thus, and as cells 20 are inserted into area 18, the outer configuration of cells 20 allows for each individual cell to be engaged and received within a complementary receiving area of battery case 10.

In accordance with an exemplary embodiment, a 36 volt battery is constructed with a battery case 10 that is configured to receive and engage 18 cells each providing approximately 2.1 volts. Each cell has a plurality of positive and negative lugs arranged at opposite ends of cell. The positive lugs are secured to a positive plate strap 39 and the negative lugs are secured to a negative plate strap 43 (FIG. 13). Alternatively, each cell is configurable to receive and engage a plurality of positive plates, negative plates and separators for providing voltages greater than or less than 2.1 volts

Referring now to FIG. 11, the cells are inserted so that each set of positive lugs and corresponding plate strap are adjacent to a set of negative lugs and corresponding plate strap in an alternating fashion. Thus, the cells via plate straps 39 and 43 are positioned for securement to each other in series in order to provide a battery having 36 volts.

FIGS. 1 and 11 illustrate a battery case 10 configured for providing 36 volts via an eighteen cell arrangement. As an alternative, and in accordance with the present invention, battery case 10 is configured to provide 36 volts via an eighteen cell arrangement through the use of other cell configurations. For example, two rows of nine cells each may be positioned side-by-side. Other configurations are also contemplated such as including but not limited to three rows of six cells each.

As yet another alternative, battery case 10 is configured to provide varying voltages greater than or less than 36 volts with a single row or multiple row cells.

Thus, battery case 10 is configured to provide a battery with the desired current and voltage capabilities.

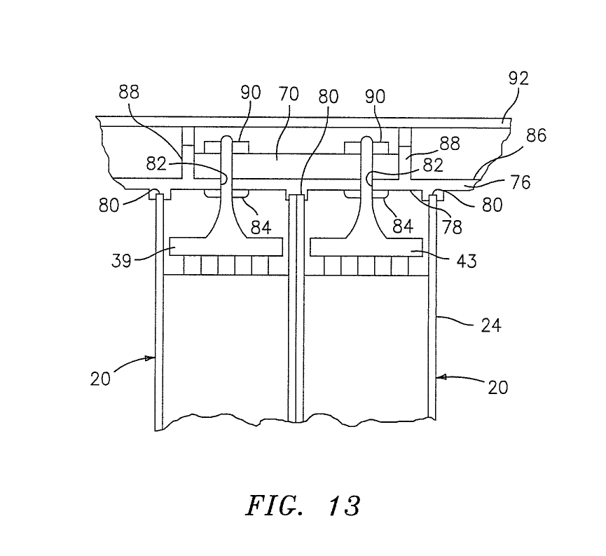

Referring now to FIGS. 11-13, battery case 10 is illustrated with eighteen cells inserted into opening 18. Each cell is inserted in an alternating arrangement so that the lugs of opposite polarity are adjacent to each other. This allows the lugs via plate straps to connect each cell in series in order to provide a battery with the required voltage.

In order to connect each adjacent plate strap to each other a plurality of lead inserts 70 are provided to provide a means for electrically connecting the posts of a negative plate to the posts of the adjacent positive plate.

At one end of the plurality of cells is an open positive plate 72, which in this case provides a positive terminal connection for the battery and at the opposite end is an open negative plate 74 which in this embodiment provides the connection for the negative terminal.

Referring now to FIG. 13, a cross-sectional view of the connection on a pair of cells is illustrated. Here after cells 20 are inserted into case 10, a first cover 76 is inserted into battery case 10 and it is configured to engage cells 20. First cover 76 has a lower surface 78 with a plurality of channels or receiving area is 80 configured for engaging walls 24 of cells 20.

First cover 76 is configured to engage both the cells and the battery case after it is inserted therein. The first cover is then secured in place by a heat sealing method. Alternative methods of securement include but are not limited to the use of adhesives, heat staking, vibration welding, ultrasonic welding and equivalents thereof.

Due to the over thickness of cells 20 being approximately 18.5 mm the size of cell 20 does not allow for welding methods (e.g. “extrusion and fusion”) through the partitions of the cell. Thus, the cells are welded to each between a first cover and an outer cover of the battery. This process is illustrated in FIG. 13.

First cover 76 is configured to have a plurality of openings 82 through which a portion of posts of plate straps 39 and 43 are capable of passing therethrough. In addition, an 0-ring 84 is positioned to provide a seal around the terminals passing through openings 82.

An upper surface 86 of first cover 76 is configured to have a plurality of retaining walls 88 positioned to retain lead insert 70 as it is inserted into an area defined by retaining walls 88.

Accordingly, and in accordance with an exemplary embodiment lead insert 70 is inserted into the area defined by retaining walls 88. Lead insert 70 is pre-cast or stamped and configured to be inserted into the defined area. Lead insert 70 is provided with an opening to allow the terminals of plated 39 and 43 to pass therethrough as the insert is positioned in the desired location. O-rings 84 prevent leakage through first cover 76 as the terminals are being welded to the inserts, as the heat from the welding process may melt a portion of the lead insert.

Once the lead insert has been inserted the terminals of plates 39 and 43 are welded to lead inserts 70 through the use of a Tungsten inert gas (TIG) weld 90.

As a final step an outer cover 92 of the battery case is installed over inner cover 76 and the associated welds. Our cover 92 is secured through adhesive bonding, ultrasonic welding or other securement methods.

Housing 21 allows for pre-assembly of individual battery cells 20 prior to placing the cell into battery case 10. Thus, cells 20 are capable of being manufactured in an entirely separate assembly process. The assembled cells are then inserted into the battery case having a predefined configuration to mate with a predefined configuration of the outer housing of the battery cell.

A first cover is inserted over the terminals of the plates of the individual cells. A plurality of lead inserts are provided for welding adjacent terminals to each other, once the welding processes is complete an outer cover is secured to the battery in accordance with preferred manufacturing processes.

In addition, each housing 21 is adapted to receive a stack of and aids in the alignment of positive plates, negative plates and separators in order to provide for error proof placement of the same within the housing. The stack is maintained under compression to provide contact between positive battery plates, the separator and the negative battery plates. More specifically, housing 21 is adapted to provide the necessary compression to the stack. Thus, housing 21 is dimensioned and sized, relative to the size of the stack, to maintain the stack under a predetermined amount of compression along a single axis, yet allows for the growth of the plates in other axes for proper battery function.

Accordingly, housing 21 provides stability to cell 20, which allows for a reduction in the thickness of battery case 10 as a result of the structural stability being provided to the cell by the housing. Moreover, the housing provides for a uniform compression by compartmentalizing the compression of each cell.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A battery, comprising:
a battery housing defining a receiving area, said housing being configured to receive and engage a plurality of cells each having a cell housing;
a cell element being received and engaged within each of said cell housings, said cell element comprising a plurality of positive plates each having a positive tab portion depending outwardly from a periphery, a plurality of negative plates each having a negative tab portion depending outwardly from a periphery, and a nonconductive separator disposed in between said plurality of positive plates and said plurality of negative plates;
a positive plate being secured to each of said positive tab portions of said cell element, said positive plate including a positive post;
a negative plate being secured to each of said negative tab portions of said cell element, said negative plate including a negative post; and
an inner cover being configured to cover said positive and negative plates, said inner cover being configured to allow a portion of said positive and said negative posts to pass therethough.

2. The battery as in claim 1, wherein said inner cover defined a plurality of receiving areas for receiving a lead insert.

3. The battery as in claim 2, wherein said plurality of receiving areas are defined by a plurality of retaining walls.

4. The battery as in claim 3, wherein said plurality of retaining walls surround a pair of openings being configured to allow a positive post and a negative post of adjacent cell elements to pass therethrough.

5. The battery as in claim 1, wherein said opening includes an O-ring being configured to receive and engaged in portion of said positive post and said negative post as they pass through said openings.

6. The battery as in claim 2, wherein said lead insert electrically connects a positive post of a first cell element to a negative post of an adjacent cell element.

7. The battery as in claim 1, wherein each of said cell elements is connected in series to an adjacent cell element.

8. The battery as in claim 7, wherein each cell housing has an outer configuration being configured to the received within a complementary receiving area defined in said battery housing.

9. An outer housing for a cell element of the battery, comprising:
an internal receiving area defined by a pair of opposing walls, a pair of sidewalls disposed between said pair of opposing sidewalls and a bottom, said outer housing defining a lower end portion, an upper portion and a transitional portion, said transitional portion being disposed between said lower end portion and said upper portion, said outer housing defining an outer configuration for being received and engaged in a complementary configuration of a battery housing.

10. A battery cell, comprising:
a) a cell element, comprising:
i) plurality of positive plates each of said plurality of positive plates having a positive lug;
ii) a plurality of separators; and
iii) a plurality of negative plates each of said negative plates having a negative lug, said plurality of positive plates, said plurality of separators, and said plurality of negative plates being configured into a compressible stack;
b) a casing for receiving said cell element;
c) a positive end plate having a positive post, said positive and plate being secured to said positive lugs; and
d) a negative end plate having a negative post, said negative end plate being secured to said negative lugs.

11. A battery, comprising:
a) a plurality of cell elements each having:
i) a plurality of positive plates each of said plurality of positive plates having a positive lug;
ii) a plurality of separators; and
iii) a plurality of negative plates each of said negative plates having a negative lug, said plurality of positive plates, said plurality of separators, and said plurality of negative plates being configured into a compressible stack;
b) a plurality of casings for receiving said plurality of cell elements;
c) a plurality of positive end plates each having a positive post, said positive end plates being secured to said positive lugs of said plurality of cell elements;
d) a plurality of negative end plates each having a negative post, said negative end plates being secured to said negative lugs of said plurality of cell elements;
e) a housing being configured to receive and engage said plurality of casings; and
f) an inner cover being configured to cover said plurality of cell elements, said inner cover having a plurality of openings being configured and positioned to allow adjacent positive and negative posts to pass therethrough.

12. A method for assembling a battery having a plurality of cells, comprising:
inserting a plurality of cells each having a cell housing into a battery housing having an internal configuration for receiving and engaging a complementary external configuration of said cell housing; and
electrically connecting each of said plurality of cells in series by providing a plurality of lead inserts for making contact with a positive post and a negative post of said plurality of cells.

13. The method as in claim 12, wherein said lead inserts are welded to said positive post and said negative post of said plurality of cells.

14. The method as in claim 13, wherein said lead inserts are positioned above a cover portion inserted between said plurality of cells and said lead inserts and a portion of said positive posts and a portion of said negative posts pass through openings in said cover portion.
